(19) United States
(12) Patent Application Publication
(10) Pub. No.: US 2009/0187581 A1
(43) Pub. Date: Jul. 23, 2009

(54) CONSOLIDATION AND ASSOCIATION OF STRUCTURED AND UNSTRUCTURED DATA ON A COMPUTER FILE SYSTEM

(76) Inventors: Vincent Delisle, Ottawa (CA); Eric Dumont, Gatineau (CA)

Correspondence Address: Teitelbaum & MacLean, 280 Sunnyside Avenue, Ottawa, ON, K1S 0R8, CA

(21) Appl. No.: 12/017,488

(22) Filed: Jan. 22, 2008

(51) Int. Cl. G06F 17/30

(52) U.S. Cl. 707/100; 707/E17.044

(57) ABSTRACT

The present invention discloses systems and methods used to consolidate and associate structured and unstructured data together on a file system. File systems are far more efficient for handling unstructured data than conventional databases. File systems can also contain a large volume of structured data serialized in XML (extensible Markup Language). File systems have a lower purchase and maintenance cost than conventional databases. Unfortunately, file systems don't provide fast access to structured data like most databases. File systems also lack the ability to associate data together like relational databases. Solutions to the structured-data access and data association problems are demonstrated in the present invention.

### TECHNICAL FIELD

The present invention relates to the field of structured and unstructured data management, and in particularly to a non-hosted content management systems for business applications.

### BACKGROUND OF THE INVENTION

Corporate data is generally scattered across multiple databases, file servers and user's computers in the form of structured data and unstructured data. Typically, structured data lives in databases, while unstructured data, e.g. documents and emails, are stored on file servers. Creating, searching, retrieving and maintaining data in such an environment is complex, expensive and prevents many applications from interacting with each other.

The obvious solution is to consolidate all structured and unstructured data together in a common repository, which has been proven to be difficult because of the disparities between structured and unstructured data. Structured data is information saved against a schema, whereby one knowing the schema can easily extract information from the structured data. An example of structured data is the records of databases, wherein the columns of each table define the schema of the records. Another example of structured data is an eXtensible Markup Language (XML) stream. An XML stream contains information that can be parsed against a known schema. Saving the XML stream in a file creates a structured data file.

Alternatively, unstructured data doesn't have a specific schema. The process of extracting information is more complex. Examples of unstructured data are word processing documents, design files, media files and emails. Unstructured data files are generally far more voluminous than structured data files. By example, a movie clip can be a million times larger than a contact record.

There are four conventional solutions to solve the problem:

In the first solution, a unique database is used to consolidate all structured and unstructured data together, but this solution has many limitations. First, such a database is very expensive to buy and to maintain. Secondly, a large volume of data can clog the database making it slow and inefficient. Thirdly, significant amounts of data can be lost if the database get corrupted.

In the second solution, some of the first solution's problems are avoided by using two databases: a first one for the structured data, and a second one for the unstructured data. While avoiding performance issues with the structured data, this solution still has significant performance limitations for large volumes of unstructured data.

In the third solution, the unstructured data is left on the company file servers. A database is used to record structured data and links to the unstructured data files. While avoiding any issue with the volume of data, this solution is fragile because links are broken when people move files and folders around. Also, users have to log into the database application to create links every time they create a new document.

In the fourth solution, complex and expensive connectors are used that can tap in all databases and file servers to give a unified view of all the company data. This solution is very expensive and complex since it still requires the purchase and maintenance of multiple databases and file servers with the added cost of all the required connectors.

An object of the present invention is to overcome the shortcomings of the prior art by organizing and consolidating corporate data and documents in a unified low-cost system that doesn't have the performance and access limitations of databases.

### SUMMARY OF THE INVENTION

The present invention discloses systems and methods used to consolidate and associate structured and unstructured data together on a file system. A file system is a very low-cost solution that doesn't suffer from database limitations for large volume of unstructured data. On the other hand, file systems are not designed to record and serve efficiently structured data or to keep relations in between them like relational databases.

A first embodiment of this invention shows how it is possible to store structured data on a file server using the XML technology and how it can be associated to unstructured data files. The relation in between the structured data and the unstructured data is established by controlling the name of the structured data files and their “associated folders”.

Another embodiment demonstrates how structured and unstructured data can be accessed efficiently by dynamically building tables out of their content.

Another embodiment demonstrates how the tables can be kept up-to-date with programs that scan, crawl and monitor the file system.

Accordingly, the present invention relates to a system for consolidating and associating structured and unstructured data on a computer file system, which stores files and folders hierarchically, comprising:

a parent folder on the computer file system;

an association identifier used to associate the structured and unstructured data;

a structured-data file stored in the parent folder, the structured-data file containing the structured data, and having a filename containing the association identifier;

an associated folder located in the parent folder, the associated folder having a name containing the association identifier;

an unstructured-data file saved within the hierarchy of the associated folder and containing the unstructured-data; and

a computer program capable of determining the association between the structured-data and the unstructured-data associated therewith using the association identifier.

Another aspect of the present invention relates to a system for consolidating and associating structured and unstructured data on a computer file system, which stores files and folders hierarchically, comprising:

a parent folder on the computer file system;

a structured-data file located in the parent folder;

an unstructured-data file associated with the structured-data file, the unstructured-data file saved within the hierarchy of the parent folder; and

at least one computer program able to discover the association between the structured-data file and the unstructured-data file by determining that the structured-data file is saved under the parent folder that contains the unstructured-data file.

Alternatively, the present invention relates to a system for associating primary structured data and secondary structured data on a computer file system, which stores files and folders hierarchically, comprising:

a parent folder on the computer file system;

an association identifier used to associate the primary structured data and secondary structured data;

a primary structured-data file stored in the parent folder, the primary structured-data file containing the primary structured data, and having a filename containing the association identifier;

an associated folder located in the parent folder, the associated folder having a name containing the association identifier;

a secondary structured-data file stored in the associated folder, the secondary structured-data file containing the secondary structured data;

a computer program capable of determining the association between the primary structured-data and the secondary structured-data associated therewith using the association identifier.

Another embodiment of the present invention relates to a method for consolidating and associating structured and unstructured data on a computer file system, which stores files and folders hierarchically, comprising the steps of:

a) generating a first structured-data file containing first structured data, related to first unstructured data, and having a filename that contains a first identifier;

b) saving the first structured-data file under a parent folder;

c) generating a first associated folder inside the parent folder with a first name that contains the first identifier;

d) saving the first unstructured data as first unstructured-data files inside the first associated folder;

e) generating a second structured-data file containing second structured data, related to second unstructured data, and having a filename that contains a second identifier;

f) saving the second structured-data file under the parent folder;

g) generating a second associated folder inside the parent folder with a second name that contains the second identifier;

h) saving the second unstructured data as second unstructured-data files inside the second associated folder; and

i) performing an initial scan of all or a part of the file system to compile, in at least one table, all or a part of the structured data found in the first and second structured-data files.

The present invention also relates to A method for consolidating and associating structured and unstructured data on a computer file system, which stores files and folders hierarchically, comprising the steps of:

a) generating a structured-data file containing the structured-data;

b) saving the structured-data file under a parent folder;

c) saving the unstructured data as an unstructured-data file inside the hierarchy of the parent folder; and

d) discovering the association between the structured-data file and the unstructured-data file by searching recursively the parent folders of the unstructured-data file to find out the structured-data file.

### BRIEF DESCRIPTION OF THE DRAWINGS

The invention will be described in greater detail with reference to the accompanying drawings which represent preferred embodiments thereof, wherein:

FIG. 1 illustrates how unstructured data files are associated with a structured data file by using an “associated folder” with a name containing a unique identifier;

FIG. 2 illustrates how unstructured data files are associated with a structured data file by collocating them in a dedicated folder having a name related to the structured data;

FIG. 3 illustrates how secondary structured data files are associated with a primary structured data file by using an “associated folder” with a name containing a unique identifier;

FIG. 4 illustrates how one can efficiently access and report on structured and unstructured data saved as files by dynamically building tables and databases out of their content; and

FIG. 5 illustrates how dynamic tables built from the structured and unstructured source data files can be kept up-to-date with the uses of a crawler or a file watcher.

### DETAILED DESCRIPTION

The present invention discloses systems and methods used to consolidate and associate structured and unstructured data together on a file system. File systems are far more efficient to handle unstructured data than conventional databases. File systems can also contain a large volume of structured data serialized in XML (eXtensible Markup Language). XML is a preferred file format because it is highly flexible and recognized as an international standard to exchange structured data in between applications. File systems also have a lower purchase and maintenance cost than conventional databases. On the other hand, file systems don't provide fast access to structured data like most databases. File systems also lack the ability to associate data together like relational databases. Files in conventional file systems don't contain links or pointers to other files to associate them. Solutions to the access and data association problems are also covered in this invention.

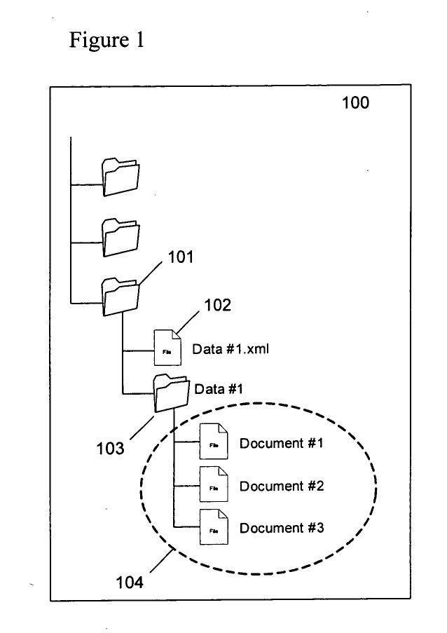

With reference to FIG. 1 the data association problem of a computer file system 100 can be solved by using an “associated folder” 103 as a link between a plurality of unstructured data files 104 and a structured data file 102 in a parent folder 101. Each structured data file 102 contains structured data serialized with the eXtensible Markup Language (XML) or other suitable structure data language. The unstructured data files 104, that need to be associated with the structured data of the data file 102 are saved under the hierarchy of the associated folder 103.

Two things are required to associate the structured data file 102 with the “associated folder” 103: first, the structured data file 102 needs to be collocated with the “associated folder” 103 in the same parent folder 101; secondly, the name of the structured data file 102 needs to share a unique association identifier, e.g. alpha-numeric or other symbol, with the name of the “associated folder” 103. This unique identifier can also be called an “association identifier”. The easiest way to ensure that the identifier is unique inside the parent folder 101 is to automatically generate the unique identifier from a portion of the data contained in the structured data of the structured data file 102. Alternatively, a user can generate his own name for the structured data file 102 based on the name of the associated folder 103 or the unstructured data files 104.

For example, the structured data could represent all the information about an employee of a company. That information will be manually entered or somehow downloaded from an existing database, and will be serialized in XML and saved in the structured data file 102. In this case, the unique identifier could be the employee number, the employee name, the employee insurance number or a combination thereof. The filename of the structured data file 102 would be composed of the identifier with an optional suffix or an optional prefix. In this example, we are choosing the employee number #001 as the identifier. In this case, using prefix or suffix, the name of the structured data file 102 could be set to one of the following: “#001.xml”, “Employee-#001.xml”, “#001.employee” or “#001-Employee.xml”. Similarly, the name of the “associated folder” 103 will have to contain the same identifier and could become one of the following: “Employee-#001.xml_{af}”, “{af}_Employee-#001”, “Employee-#001”.

Choosing a dedicated file extension, e.g. “.employee” as in the previous example, has the advantage that file browsers are better able to identify the file's content, to thereby associate the file with a custom icon when presenting the file to a user. The technique of using an “associated folder” 103 sharing the same identifier as the file 102 and collocated with it as the following advantages:

1—The association between the structured data file 102 and the unstructured data files 104 won't be broken when the parent folder 101 or the file system 100 are moved, since all the structured and unstructured data files 102 and 104 are moved together.

2—Other structured data files 104 can be added to the parent folder 101 without breaking the association of the structured data file 102 and the “associated folder” 103.

3—The “associated folder” 103 can contain as many unstructured data files 104 as desired. The additional unstructured data files 104 can also be grouped in sub-folders without loosing their association to the structured data of structured data file 102.

4—It is easy for a program knowing the prefix of suffix of the “associated folder” 103 to discover the association by comparing the names of all the files and folders contained in the parent folder 101, which can efficiently be done by using a hash table containing either the names of all the structured data files 102 or the names of all the associated folders 103 for fast comparisons.

5—It is also easy for a user accessing the parent folder 101 with a file browser to visually recognize the association in between the structured data file 102 and the “associated folder” 103.

Associating unstructured data with structured data has the overall advantage of giving a context to the unstructured data. For example, an indexer program can find all the documents on a file system 100 and relate them to the content of their associated structured data. The indexer can then process complex queries involving structured and their related unstructured data. By example, an indexer can be used to search for all of the documents containing the word “Contract” that are associated with a structured data file describing customer information where one of the information could be the annual revenue of the customer and should be greater than $10,000,000. The indexer will perform this task by: 1—finding a document in the files 104 containing the word “Contract”; 2—reading all the file names and folder names in the parent folder 101; 3—discovering the association in between the “associated folder” 103 and the structured data file 102; 4—reading the contents of file 102 to find out if the information within matches the query of a customer having an annual revenue of $10,000,000; 5—returning the document the case of a positive match.

Alternatively, if the file system 100 supports attributes on folders, then one of the folder attributes of the “associated folder” 103 can be used to associate the folder 103 with the structured data file 102. The attribute can be a tag, an identifier or any other information that will be unique to the structured data contained in the structured data file 102.

Another less interesting way to associate the structured data file 102 to the “associated folder” 103 is to record the path where the “associated folder” 103 is located inside the structured data file 102.

A hash table can be used to improve the speed at which a program will find out the association in between a structured data file 102 and an “associated folder” 103. First all file names and folder name from the parent folder 101 are read and cleaned up from any prefix, suffix or extension. The trimmed file names are then added to an hash table. Each trimmed folder name is then compared to the trimmed file name of the hash table. The hash table make this comparison extremely quickly by comparing the hash value of the trimmed folder name with the trimmed values of all the trimmed file named.

An other way to speed up the discovery of associations in between structured data and unstructured data is to first scan the file system 100 and to record all the associations in a database. When a program needs to find out if some structured or unstructured data is associated with any other data, it can query the database directly.

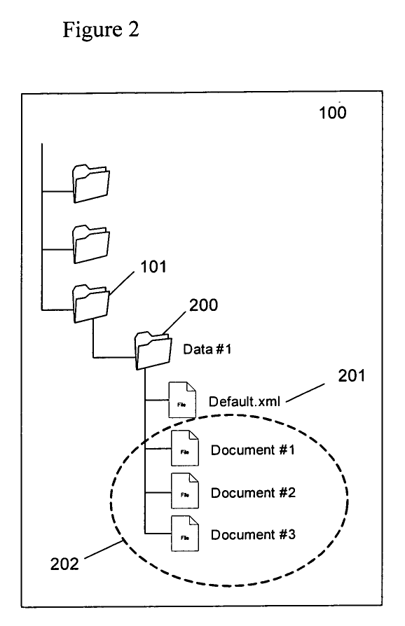

FIG. 2 illustrates a different technique to associate unstructured data files 202 with a structured data file 201 by using a “dedicated” associated folder 200 within the parent folder 101 on the file system 100.

In this embodiment, one or many unstructured data files 202 are associated with a structured data file 201 by collocating them together in the dedicated folder 200. Two things are required for this technique to work: first, the name of the “dedicated folder” 200 contains a unique identifier to prevent name collision inside the parent folder 101, and to give users an easy way to recognize the contained structured data when browsing the parent folder 101. The preferred way to generate this identifier is to use information found inside the structured data file 201. By example, if the structured data file 201 defines an employee, then the unique identifier could be the employee number, the employee name or the employee insurance number. The name of the “dedicated folder” 200 could be set to: “Employee-#001”, “#001”, “#001-Employee”. Secondly, the structured data file 201 needs to have a name that identifies it as the primary structured data file defining the context of the “dedicated folder” 200. For example, the name of the structured data file 200 can be set to: “Default.xml”, “Employee.xml”, “Default.employee”.

This embodiment has the following advantages over the previous embodiment: 1) the parent folder 101 only contains one folder 200 for each structured to unstructured data association; and 2) only one folder 200 needs to be renamed when the data that generates the identifier is changed, since the structured data file 201 is already within the dedicated folder 200.

This embodiment has the following disadvantages over the previous embodiment: 1) a dedicated folder 200 always needs to be created even when no unstructured data files 202 are to be associated with the structured data file 201; and 2) the structured data file 201 doesn't necessarily reflect its identity when detached from its parent folder 200, e.g. when the structured data file is emailed.

Alternatively, the name of the structured data file 201 can also contain the identifier used for the name of the “dedicated folder” 200. This is a lesser interesting technique because two objects have to be renamed when the data that generates the identifier is changed.

The unstructured data files 202 can also be grouped in sub-folders without loosing their association to the structured data file 201 as long as they stay inside the hierarchy of the “dedicated folder” 200.

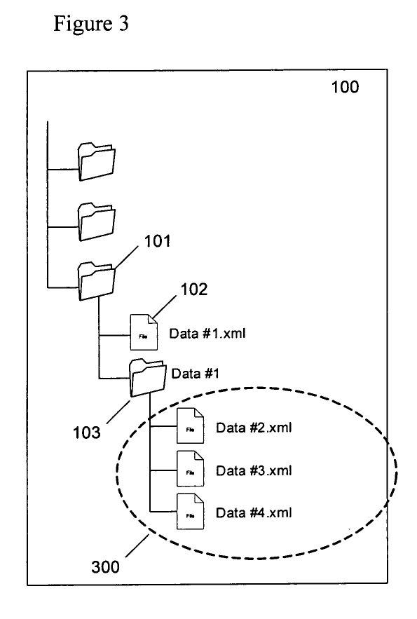

With reference to FIG. 3, the association technique of the first embodiment can be extended to encompass the association of the primary structured data file 102 to many secondary structured data files 300 in each of the parent folders 101 on the file system 100. This technique is similar to the first embodiment of this invention except that the unstructured data files 104 of the first embodiment are replaced with structured data files 300 that need to be associated with the primary structured data file 102.

As an example, the structured data file 102 could represent a company project and be called “Project #1.xml”. The “associated folder” 103 could then be called “Project #1”. Tasks, e.g. deadlines, of the project can be saved within the hierarchy of the “associated folder” 103 as secondary structured data files 300 without having an unstructured data file associated therewith. The tasks are then associated and virtually dependent of the parent project structured data file 102. The hierarchic association of structured data can also be extended to contain unstructured data files within the associated folder 103 relating to the secondary structured data files 300 or the primary structured data file 102, whereby a database can be build out of that hierarchy that will contain records containing information coming from one of the secondary structured data files 300 and the primary structured data file 102.

Another technique to increase the benefit of the present invention is to use a status determining computer program that can update the data inside the structured data file 102 with some information found inside the content of the “associated folder” 103. For example, the structured data file 102 could define a company project, while the structured data files 300 define dependant tasks therefrom. When run, the computer program will find the status of all of the dependant tasks from the secondary structured data files 300, and update the overall status of the parent project in the primary structured data file 102. The status determining computer program is also applicable for use with the first embodiment, illustrated in FIG. 1, in which the associated content is the unstructured data files 104.

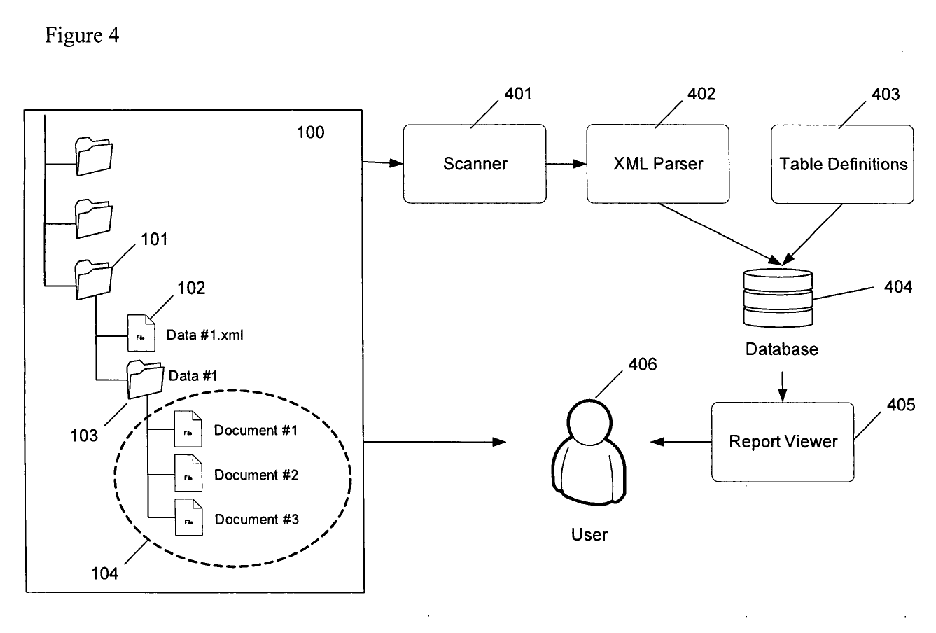

FIG. 4 illustrates a technique to resolve the access time limitations of the file system 100 for structured data by dynamically building a database 404 out of all the required data in all the required structured data files, e.g. 102. In the illustrated embodiment, the file system 100, from FIG. 1, could contain numerous folders, e.g. folder 101, each containing numerous structured data files, e.g. structured data file 102. A scanner computer program 401 is used to scan all or a part of the file system 100 to discover all the required structured data files, e.g. file 102. When a new structured data file is discovered, an XML parser 402 is used to retrieve the data contained therein. A new record is then added to a table of the database 404 filled with information found in the newly discovered structured data file.

A table definition 403 detailing the desired information and/or fields is used to create the required tables in the database 404, and to map the data coming from the structured data files 102 to the proper columns of the tables of the database 404. A user 406 can use a custom or a generic reporting tool 405 to view the contents of the database 404. Other business applications can also tap into the database 404 to query data that would normally only be found on the file system 100.

The main advantages of this technique are: 1) the database 404 offers flat and fast access to all the structured data living on the file system 100; 2) the database 404 can be rebuilt easily if it gets corrupted, since the source of the information is not kept in the database, but in the structured data files 102; 3) the database 404 doesn't require a backup, since the source of the information is not kept in the database, but in the structured data files 102; 4) multiple scanner programs can fill multiple databases for different business applications out of the same source files, e.g. information relating to sales, can be retrieved, saved in a first database and displayed for salespeople, while information relating to customer support can be retrieved, saved in a second database and displayed for customer support personal.

This technique is not limited to structured data. The scanner program 401 can also extract information from some of the unstructured data files 104 to fill the database. As an example, a file system 100 is used to contain two thousand structured data files representing contacts in a company. The scanner program 401 will scan the file system 100 to discover the two thousand files, and then create a new “Contact table” in the database 404 defined by the table definition 403. The scanner program 401 will then fill that table with two thousand records containing some of the contacts information, e.g. the name of the person, the phone number or the address. A user 406 will be able to see the complete list of all the contacts in the database 404 or a subset of the contacts in the database 404 defined by the user 406 or defined by the company. An advantage of the present invention is that the user 406 can also access the file system 100 and all the structured and unstructured data files 102, 103 and 104 by conventional means, as well as access and search the data via conventional searching tool.

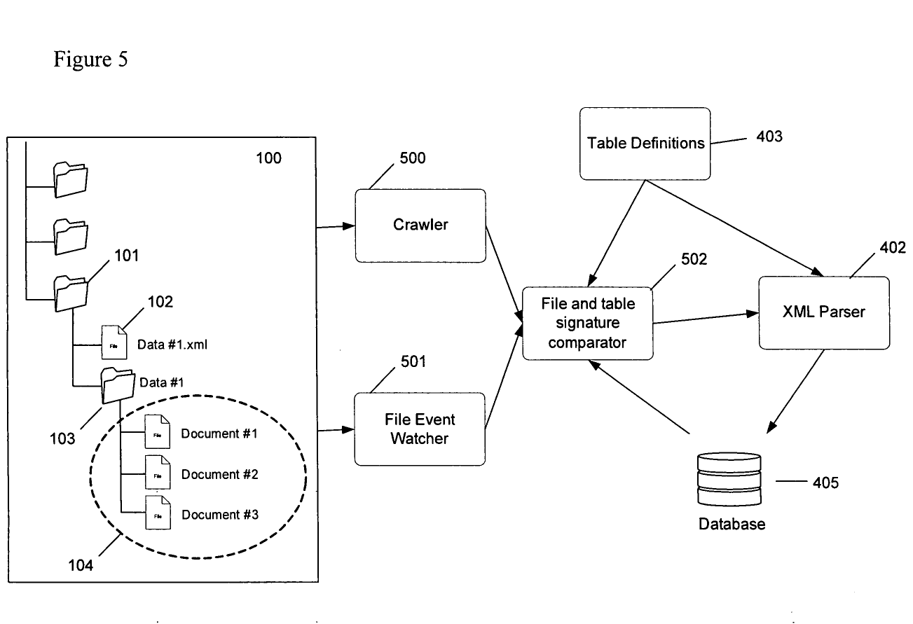

The scanner 401 is used as an initial step to retrieve all of the original structured data required to populate the database(s) 404; however, FIG. 5 illustrates how the dynamic database 404 of the previous embodiment can be kept up-to-date using a crawler program 500 or a file event watcher 501. A crawler program 500 is used to continuously or sporadically scan the file system 100 to discover files that might have changed since they were last parsed. A procedure 502 will decide if any database records need to be updated for the files found by the crawler program 500. Two main conditions can trigger the update: 1) the last modified time of the file is different than the last time the file was parsed by the XML parser 402; or 2) the table definitions 403 that apply to the file have changed.

Optionally, the size of the file can also be used to trigger an up-date. This is useful when the file system time is not precise enough and a file could be modified twice within the resolution of the last modified time of the file. A hash code of the file can also be computed to decide if a file should be parsed again.

A file event watcher 501, as provided by computer operating systems can also be used to discover files that might require parsing again. Like in the case of the crawler 500, the file watcher 501 send the information of files that might have changed to the procedure 502 to determine if they should be parsed again. File time signature, table definitions 403, file size or file hash value can all be used to determined if parsing is required.

We claim:

1. A system for consolidating and associating structured and unstructured data on a computer file system, which stores files and folders hierarchically, comprising:
a parent folder on the computer file system;
an association identifier used to associate the structured and unstructured data;
a structured-data file stored in the parent folder, the structured-data file containing the structured data, and having a filename containing the association identifier;
an associated folder located in the parent folder, the associated folder having a name containing the association identifier;
an unstructured-data file saved within the hierarchy of the associated folder and containing the unstructured-data; and
a computer program capable of determining the association between the structured-data and the unstructured-data associated therewith using the association identifier.

2. The system according to claim 1, further comprising:
a plurality of additional structured-data files in the parent folder, each additional structured data file containing structured data, and having a filename containing a unique association identifier;
a plurality of additional associated folders located in the parent folder, each additional associated folder having an association with one of the structured data files, and having a name containing the same association identifier used in the filename of the structured-data file it is associated with; and
at least one additional unstructured-data file saved within the hierarchy of each of the additional associated folders;
wherein the computer program is capable of determining the associations between the structured-data files and the unstructured-data files associated therewith using the association identifiers.

3. The system of claim 1, wherein the computer program uses a hash table to reduce the time required to compare the structured-data filenames and the associated folder names.

4. The system of claim 2, further comprising:
a first scanning computer program for performing an initial scan of all or a part of the file system to compile, in at least one table, all or a part of the structured data found in the structured-data files.

5. The system of claim 4, further comprising a second scanning program for continuously or sporadically scanning all or a part of the file system to update the at least one table with data found in the structured-data files that have been modified since the initial scan.

6. The system of claim 5, wherein the second scanning program uses the last modified time of each structured-data files to decide if the data therein has changed.

7. The system of claim 5, wherein the second scanning program uses the last modified time and a size of the structured-data files to decide if the data therein has changed.

8. The system of claim 5, wherein the second scanning program compile a hash code of the structured-data files to decide if the data therein has changed.

9. The system of claim 4, further comprising a file event watcher to determine, in real time, whether the data in the structured-data files has changed.

10. The system of claim 2, further comprising an updating computer program for updating the structured data of the structured-data files with information obtained from any of the unstructured-data files.

11. The system of claim 2, further comprising a parsing program for scanning all or a part of the file system to compile a partial or a complete index of the unstructured-data files found within the hierarchy of the associated folders and associate the unstructured-data files with data found in the structured-data files.

12. A system for consolidating and associating structured and unstructured data on a computer file system, which stores files and folders hierarchically, comprising:
a parent folder on the computer file system;
a structured-data file located in the parent folder;
an unstructured-data file associated with the structured-data file, the unstructured-data file saved within the hierarchy of the parent folder; and
at least one computer program able to discover the association between the structured-data file and the unstructured-data file by determining that the structured-data file is saved under the parent folder that contains the unstructured-data file.

13. A system for associating primary structured data and secondary structured data on a computer file system, which stores files and folders hierarchically, comprising:
a parent folder on the computer file system;
an association identifier used to associate the primary structured data and secondary structured data;
a primary structured-data file stored in the parent folder, the primary structured-data file containing the primary structured data, and having a filename containing the association identifier;
an associated folder located in the parent folder, the associated folder having a name containing the association identifier;
a secondary structured-data file stored in the associated folder, the secondary structured-data file containing the secondary structured data;
a computer program capable of determining the association between the primary structured-data and the secondary structured-data associated therewith using the association identifier.

14. The system of claim 13, further comprising a scanning computer program for scanning all or a part of the file system to compile, in at least one table, all or a part of the structured data found in the primary and secondary structured data to speed up the access time to the structured data.

15. The system of claim 13, further comprising a scanning computer program for scanning all or a part of the file system to compile in at least one record of one table information from the primary structured-data file and one of the associated secondary structured-data files.

16. A system for associating primary structured data and secondary structured data on a computer file system, which stores files and folders hierarchically, comprising:
a parent folder on the computer file system;
a first structured-data file in the parent folder containing the primary structured data;
a second structured-data file saved within the hierarchy of the parent folder and containing the secondary structured data; and
at least one computer program able to discover the association between the primary structured-data and its associated secondary structured data by determining that the second structured-data file is saved under the hierarchy of the parent folder containing the first structured-data file.

17. A method for consolidating and associating structured and unstructured data on a computer file system, which stores files and folders hierarchically, comprising the steps of:
a) generating a first structured-data file containing first structured data, related to first unstructured data, and having a filename that contains a first identifier;
b) saving the first structured-data file under a parent folder;
c) generating a first associated folder inside the parent folder with a first name that contains the first identifier;
d) saving the first unstructured data as first unstructured-data files inside the first associated folder;
e) generating a second structured-data file containing second structured data, related to second unstructured data, and having a filename that contains a second identifier;
f) saving the second structured-data file under the parent folder;
g) generating a second associated folder inside the parent folder with a second name that contains the second identifier;
h) saving the second unstructured data as second unstructured-data files inside the second associated folder; and
i) performing an initial scan of all or a part of the file system to compile, in at least one table, all or a part of the structured data found in the first and second structured-data files.

18. The method according to claim 17, further comprising:
determining the association between the first structured-data and the first unstructured-data using the first association identifier; and
accessing the first unstructured data via the first structured data file.

19. The method according to claim 17, further comprising: continuously or sporadically scanning all or a part of the file system to update the at least one table with data found in the structured-data files that have been modified since the initial scan.

20. A method for consolidating and associating structured and unstructured data on a computer file system, which stores files and folders hierarchically, comprising the steps of:
a) generating a structured-data file containing the structured-data;
b) saving the structured-data file under a parent folder;
c) saving the unstructured data as an unstructured-data file inside the hierarchy of the parent folder; and
d) discovering the association between the structured-data file and the unstructured-data file by searching recursively the parent folders of the unstructured-data file to find out the structured-data file.
